(19) United States
(12) Patent Application Publication
(10) Pub. No.: US 2017/0219875 A1
(43) Pub. Date: Aug. 3, 2017

(54) COLOR FILTER SUBSTRATE AND METHOD FOR MANUFACTURING THE SAME, DISPLAY PANEL AND DISPLAY DEVICE

(71) Applicants: BOE Technology Group Co., Ltd., Beijing (CN); Hefei Xinsheng Optoelectronics Technology Co., Ltd., Anhui (CN)

(72) Inventors: Xiong Xiong, Beijing (CN); Rongcheng Liu, Beijing (CN); Yudong Liu, Beijing (CN); Jian Zhao, Beijing (CN)

(21) Appl. No.: 15/234,000

(22) Filed: Aug. 11, 2016

(30) Foreign Application Priority Data
Jan. 28, 2016 (CN) 201610061279.3

(51) Int. Cl. G02F 1/1335; C25D 9/04; G02F 1/1343; C25D 9/02; G02B 5/00; G02B 5/20

(52) U.S. Cl. CPC G02F 1/133514; G02B 5/003; G02B 5/201; G02F 1/13439; G02F 1/133512; C25D 9/02; C25D 9/04

(57) ABSTRACT

Embodiments of the present application provide a color filter substrate, a method for manufacturing the color filter substrate, a display panel and a display device. The color filter substrate includes: a substrate; a color filter layer disposed on the substrate, the color filter layer including a plurality of sub color filter layers spaced apart from each other; a process electrode layer disposed on the substrate and within a gap between any two adjacent sub color filter layers; and a black matrix disposed within the gap between the any two adjacent sub color filter layers and on the corresponding process electrode layer, and connected with the adjacent sub color filter layer without any overlap therebetween.

### CROSS-REFERENCE TO RELATED APPLICATION

This application claims the benefit of Chinese Patent Application No. 201610061279.3, filed on Jan. 28, 2016, entitled “Color Filter Substrate and Method for Manufacturing the Same, Display Panel and Display Device” in the State Intellectual Property Office of China, the whole disclosure of which is incorporated herein by reference.

### BACKGROUND OF THE INVENTION

Field of the Invention

The present disclosure relates to a field of display technology, and more particularly to a color filter substrate and a method for manufacturing the color filter substrate, a display panel and a display device.

Description of the Related Art

A thin film transistor liquid crystal display (hereinafter called as TFT-LCD) has been widely used, due to having numerous advantages such as thin thickness of a body thereof, low power consumption, no radiation and the like. A liquid crystal display panel generally includes a color filter substrate, an array substrate assembled to the color filter substrate and a liquid crystal layer disposed between the color filter substrate and the array substrate.

A manufacturing process for the color filter substrate in the prior art typically includes: firstly, coating a material of a black matrix (BM) on a substrate, and obtaining a pattern including a black matrix by photolithography and development processes; then, successively producing sub color filter layers including BGR photoresist with taking the pattern including the black matrix as a reference by using the photolithography and development processes; then, forming respective different layer structures according to different display modes, producing post spacers (PS), and finally forming a complete color filter substrate.

In order to achieve a perfect light-shading effect, as shown in FIG. 1, the pattern of the black matrix 2 is generally at least partly overlapped with the sub color filter layer 3 formed from RGB photoresist, resulting in a height step between the pattern of the black matrix 2 and the sub color filter layer 3, thereby causing a series of adverse issues, for example, Rubbing Mura of an alignment layer, DNU (gray state distribution non-uniformity) due to obstruction to the flow of liquid crystal in a liquid crystal cell, or the like. A planarization layer (OC) 4 is provided above the color filter layer to eliminate the adverse affection of the height step, however, the planarization layer 4 generally cannot fundamentally eliminate the height step.

At present, during manufacturing the color filter substrate, a patterning process is typically used to produce various layer structures, however, the process is relatively complex. Furthermore, the provision of the planarization layer not only cannot avoid the occurrence of the height step, but also adversely affect subsequent process steps and production of post spacers 5. Therefore, it becomes an urgent technical problem currently to design a structure of a color filter substrate, which can fundamentally decrease or eliminate the height step between the pattern of the black matrix and the color filter layer, simplify the manufacturing process and effectively reduce the cost and process steps thereof.

### SUMMARY OF THE INVENTION

In order to at least partially solve or eliminate the drawbacks in the prior art, there is provided a color filter substrate and a method for manufacturing the color filter substrate, a display panel and a display device, so that the color filter substrate has a simple structure and effectively decreases a height step between a sub color filter layer and a black matrix.

In accordance with one aspect of the present application, it provides a color filter substrate, comprising:

a substrate;

a color filter layer disposed on the substrate, the color filter layer comprising a plurality of sub color filter layers spaced apart from each other;

a process electrode layer disposed on the substrate and within a gap between any two adjacent sub color filter layers; and

a black matrix disposed within the gap between the any two adjacent sub color filter layers and on the corresponding process electrode layer, and connected with the adjacent sub color filter layer without any overlap therebetween.

In one example, an upper surface of the black matrix is flush with an upper surface of the adjacent sub color filter layer.

In one example, the black matrix is formed through electrodepositing a material containing ions by means of an electric field generated by the process electrode layer.

In one example, each of a width of the black matrix and a width of the corresponding process electrode layer is equal to a width of the gap between the adjacent sub color filter layers, and a sum of a thickness of the black matrix and a thickness of the corresponding process electrode layer is equal to a thickness of the adjacent sub color filter layer.

In one example, the thickness of the black matrix is in a range of ¾ to ⅚ of the thickness of the adjacent sub color filter layer.

In one example, material of the black matrix comprises resin, colorant, curing agent, cosolvent and solvent, wherein the resin comprises acrylic resin or polyester resin, the colorant comprises carbon black or lamp black, the curing agent comprises melamine, the cosolvent comprises alcohol material or ether alcohol material, and the solvent comprises deionized water.

In one example, the process electrode layer is made of conductive material, which comprises indium tin oxide.

In one example, the color filter substrate further comprises a common electrode layer or post spacers disposed on the black matrix and the sub color filter layers.

In accordance with another aspect of the present application, it provides a method for manufacturing the color filter substrate as described above, comprising steps of:

forming a pattern comprising the plurality of sub color filter layers spaced apart from each other on the substrate of the color filter substrate;

forming the process electrode layer within the gap between the any two adjacent sub color filter layers; and

forming a pattern comprising the black matrix on the process electrode layer.

In one example, the step of forming the pattern comprising the black matrix on the process electrode layer comprises:

coating black matrix material on the process electrode layer and the sub color filter layers, and forming the pattern of the black matrix within the gap between the any two adjacent sub color filter layers by means of electrodeposition through energizing the process electrode layer, wherein the black matrix is connected with the adjacent sub color filter layer without any overlap therebetween.

In one example, material of the black matrix comprises resin, colorant, curing agent, cosolvent and solvent, wherein the resin comprises acrylic resin or polyester resin, the colorant comprises carbon black or lamp black, the curing agent comprises melamine, the cosolvent comprises alcohol material or ether alcohol material, and the solvent comprises deionized water.

In one example, the step of forming the process electrode layer within the gap between the any two adjacent sub color filter layers comprises:

forming a photoresist layer comprising a pattern of the process electrode layer on the substrate provided with the sub color filter layers, forming a process electrode film layer on the photoresist layer, and forming the process electrode layer within the gap between the any two adjacent sub color filter layers by a peeling-off process.

In one example, the process electrode layer is made of conductive material, which comprises indium tin oxide.

In one example, each of a width of the black matrix and a width of the corresponding process electrode layer is equal to the width of the gap between the two adjacent sub color filter layers, and a sum of a thickness of the black matrix and a thickness of the corresponding process electrode layer is equal to a thickness of the adjacent sub color filter layer.

In one example, the thickness of the black matrix is in a range of ¾ to ⅚ of the thickness of the adjacent sub color filter layer.

In one example, the method further comprising a step of forming a pattern of a common electrode layer on the black matrix or the sub color filter layers, or a step of forming post spacers on the black matrix or the sub color filter layers.

In one example, an upper surface of the black matrix is flush with an upper surface of the adjacent sub color filter layer.

In accordance with a yet another aspect of the present application, it provides a display panel, comprising the color filter substrate as described above.

In accordance with a yet further aspect of the present application, it provides a display device, comprising the display panel as described above.

### BRIEF DESCRIPTION OF THE DRAWINGS

FIG. 1 is a schematic structure view of a color filter substrate in the prior art;

FIG. 2 is a schematic structure view of a color filter substrate according to a first embodiment of the present disclosure;

FIG. 3 is a flow chart of a method for manufacturing a color filter substrate according to the first embodiment of the present disclosure;

FIGS. 4A-4D are respective schematic structure views of the color filter substrate corresponding to the method shown in FIG. 3; and

FIG. 5 is a schematic structure view of the color filter substrate having an ADS display mode according to the first embodiment of the present disclosure.

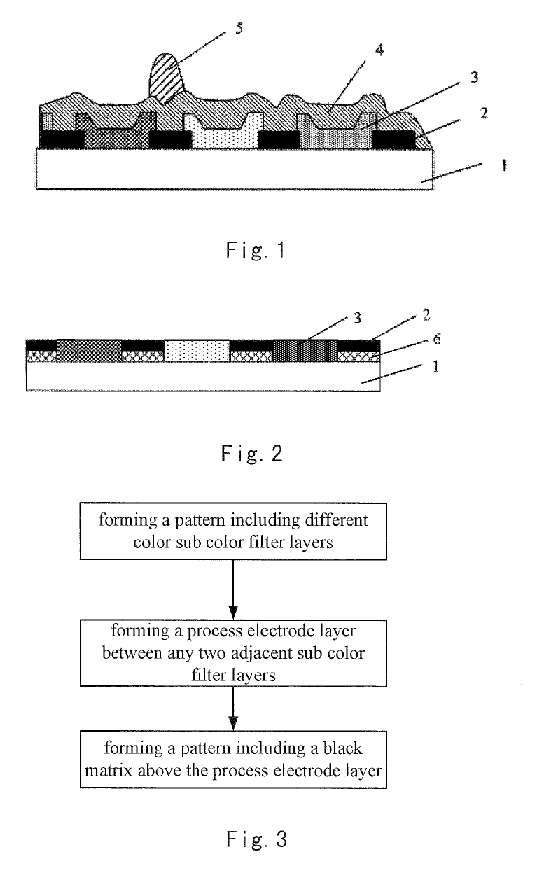

Explanation about the reference numerals in the drawings:

1—substrate; 2—black matrix; 20—material of black matrix; 3—sub color filter layer; 4—planarization layer; 5—post spacer; 6—process electrode layer; 7—power supply electrode.

### DETAILED DESCRIPTION OF PREFERRED EMBODIMENTS OF THE INVENTION

In order to provide a better understanding to the technical solutions of the present disclosure for the person skilled in the art, a color filter substrate, and a method for manufacturing the same, a display panel and a display device of the present disclosure will be further described in detail with reference to the accompanying drawings and the specific embodiments.

### First Embodiment

This embodiment provides a color filter substrate, the color filter substrate has a simple structure, and there is no height step/difference between a black matrix and a color filter layer.

As shown in FIG. 2, the color filter substrate includes a substrate 1, a color filter layer and a process electrode layer 6 disposed on the substrate and a black matrix 2. The color filter layer includes a plurality of sub color filter layers 3 spaced apart from each other. In an example, the color filter layer includes a plurality of sub color filter layers 3 having different colors, spaced apart from each other, and arranged sequentially and circularly. The process electrode layer 6 is disposed within a gap between two adjacent sub color filter layers 3. The black matrix 2 is also disposed within the gap between two adjacent sub color filter layers 3, and on the corresponding process electrode layer 6, without any overlap with the adjacent sub color filter layer 3.

In an example, an upper surface of the black matrix 2 is flush with an upper surface of the adjacent sub color filter layer 3.

In an example, the black matrix 2 is formed of a material containing ions. The material for forming the black matrix 2 may be deposited on the process electrode layer 6 under an action of an electric field generated by the process electrode layer 6, so as to form the black matrix 2.

Each of the width of the black matrix 2 and the width of the process electrode layer 6 is equal to a width of the gap between the adjacent sub color filter layers 3, and a sum of the thickness of the black matrix 2 and the thickness of the corresponding process electrode layer 6 is equal to the thickness of the adjacent sub color filter layer 3. In such a way, the upper surface of the black matrix 2 is flush with the upper surface of the adjacent sub color filter layer 3, ensuring an identical thickness everywhere, without any height step.

In an example, the thickness of the black matrix 2 is less than the thickness of the sub color filter layer 3, for example, the thickness of the black matrix 2 is in a range of ¾ to ⅚ of the thickness of the sub color filter layer 3, so that the black matrix 2 has a sufficient thickness in order to ensure a light shading effect. For example, the thickness of the sub color filter layer 3 is 1.9 μm, the thickness of the process electrode layer 6 is 0.5 μm or less, and the thickness of the black matrix 2 is 1.5 μm.

In the color filter substrate of the present embodiment, the material for forming the black matrix 2 contains ions. As an example, the material 20 for the black matrix includes resin, colorant, curing agent, cosolvent and solvent. In an example, the resin includes acrylic resin or polyester resin, the colorant includes carbon black or lamp black, the curing agent includes melamine, the cosolvent includes alcohol material or ether alcohol material, and the solvent includes deionized water. In the example, the acrylic resin or polyester resin contains ions, which may be moved relative to the process electrode layer 6 under the action of an electric field, so as to generate an electro-deposition reaction.

Meanwhile, the process electrode layer 6 is made of conductive material, which includes indium tin oxide (ITO). ITO is a common material in the field of display technology, and may be easily acquired. In the color filter substrate of the present embodiment, since the projection area of the process electrode layer 6 is completely identical to the projection area of the black matrix 2 in an orthographic projection direction, the present disclosure does not limit the transparency of the material for forming the process electrode layer 6, as long as it can be energized and achieve electrical conduction.

It should be noted that color filter substrates suitable for operating in various display modes may be further formed based on the above-described color filter substrate, for example, a common electrode layer or post spacers 5 may be disposed on or above the black matrix 2 and the sub color filter layers 3 (as shown in FIG. 5).

Compared to the conventional color filter substrate, the color filter substrate according to the present embodiment may reduce the height step between the sub color filter layer and the black matrix, decrease the adverse affection of the height step to the processes such as subsequent production of the post spacer and alignment layer rubbing, etc., and decrease the bad issues, such as Rubbling Mura, or DNU, in the subsequent processes.

Accordingly, the present embodiment further provides a method for manufacturing the above-described color filter substrate, which has simple processes and effectively reduce the process cost.

In particular, as shown in FIG. 3, the method includes steps of:

1) forming a pattern including the plurality of sub color filter layers spaced apart from each other on the substrate 1 of the color filter substrate.

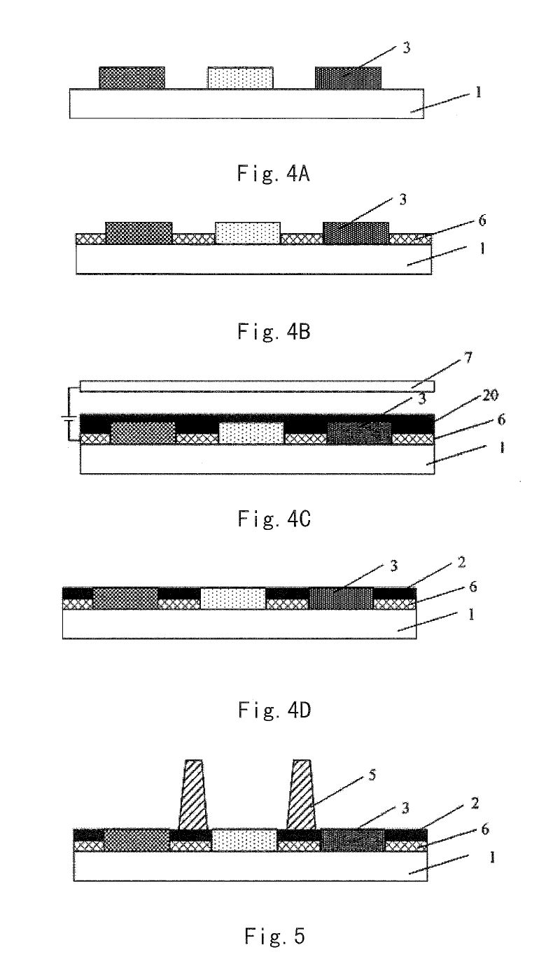

In this step, as shown in FIG. 4A, the well known patterning processes may be adopted, RGB photoresist may be produced on the substrate 1 by light exposure and development process, to form the pattern including the plurality of sub color filter layers 3 spaced apart from each other.

2) forming the process electrode layer 6 within the gap between the adjacent sub color filter layers 3.

In this step, as shown in FIG. 4B, the step of forming the process electrode layer 6 within the gap between the adjacent sub color filter layers 3 includes: forming a photoresist layer including a pattern of the process electrode layer 6, forming a process electrode film on the photoresist layer, and forming the process electrode layer 6 within the gap between the adjacent sub color filter layers 3 by a peeling-off process. As for the step of forming the process electrode layer 6 by the peeling-off process, it only requires to perform the light exposure, develop the photoresist material, while eliminating a process of etching the material for forming the process electrode, which can effectively simplify the process steps and maintain a clean and safe process environment.

In the embodiment, the process electrode layer 6 is made of conductive material, which includes indium tin oxide (ITO). ITO is a common material in the field of display technology, and may be easily acquired. In an example, the width of the process electrode layer 6 is equal to the width of the gap between the adjacent sub color filter layers 3.

In this step, as shown in FIG. 4B, the peeling-off process is only taken as one specific implementation to form the process electrode layer 6, but of course, the conventional patterning process may be adopted, the process electrode layer 6 may be produced between the sub color filter layers 3 by exposure, developing, or etching process, which is not limited herein.

3) forming a pattern including the black matrix on the process electrode layer. In this step, the step of forming the pattern including the black matrix 2 on the process electrode layer 6 includes: coating a material 20 for the black matrix on the process electrode layer 6 and the sub color filter layers 3, and forming the pattern of the black matrix 2 within the gap between the adjacent sub color filter layers 3 by means of electrodepositing through energizing the process electrode layer 6 via a power supply electrode 7, wherein the black matrix 2 is located without any overlap with the adjacent sub color filter layer 3. In an example, as shown in FIG. 4D, the width of the black matrix 2 is equal to the width of the gap between the two adjacent sub color filter layers 3, and a sum of the thickness of the black matrix 2 and the thickness of the process electrode layer 6 is equal to the thickness of the sub color filter layer 3. In such a way, the upper surface of the black matrix 2 is flush with the upper surface of the adjacent sub color filter layer 3, ensuring an identical thickness everywhere without any height step.

In an example, the thickness of the black matrix 2 is less than the thickness of the sub color filter layer 3, for example, the thickness of the black matrix 2 is in a range of ¾ to ⅚ of the thickness of the sub color filter layer 3, so that the thickness of the black matrix 2 is sufficiently thick to ensure a light shading effect.

In an example, the material 20 for the black matrix includes resin, colorant, curing agent, cosolvent and solvent, wherein the resin includes acrylic resin or polyester resin, the colorant includes carbon black or lamp black, the curing agent includes melamine, the cosolvent includes alcohol material or ether alcohol material, and the solvent includes deionized water. The above materials are mixed together to form a mixed solution, and under the action of the solvent and the cosolvent, pigment particles in the colorant, independent pigment particles, and charged ions in the resin all are in a free state.

The principle of forming the pattern of the black matrix 2 by the electrodeposition is in that: the charged ions in the resin are moved to the electrode having a corresponding polarity under the action of an electric field, the dissolved pigment particles and the independent pigment particles are also migrated together due to wrapping and towing of the resin, and precipitated with the resin on the electrode to form an insoluble colored film, thereby forming the pattern of the black matrix above the process electrode layer. In this way, the black matrix having a proper thickness may be achieved with the control of energization time and energization voltage of the process electrode.

In this step, the black matrix 2 embedded between the sub color filter layers 3 is formed by the electrodeposition, rather than the conventional patterning processes, so that the upper surface of the pattern of the formed black matrix 2 is substantially flush with the upper surface of the sub color filter layer 3. Thus, it not only saves the process steps, but also completely eliminates the height step/difference between the sub color filter layer 3 and the black matrix 2, thereby particularly facilitating subsequent manufacture of the color filter substrate arrangement.

In this step, process parameters may be comprehensively adjusted to control the electrodeposition effect, for example, energization voltage, energization current and energization time applied to the process electrode layer 6 may be comprehensively adjusted, so as to achieve an excellent deposition effect of the material 20 for black matrix, which is not limited herein. The electrodeposited color filter substrate may be delivered to the next process after being taken out from the mixed solution and being cleaned.

Based on the above-described method for manufacturing the color filter substrate, it may further include a step of forming a pattern of a protective layer on the black matrix 2 and the sub color filter layer 3, or a step of forming a pattern including a common electrode layer or post spacers 5 on the black matrix 2 and the sub color filter layer 3.

The above-described color filter substrate may be applied to various types of display panels, to ensure a good display effect. Taking an application to an ADS display mode as an example, as shown in FIG. 5, it is only necessary for obtaining the resulting color filter substrate to successively produce the sub color filter layer 3, the process electrode layer 6, the black matrix 2 and the post spacer 5. The present color filter substrate, as compared to the conventional color filter substrate applied to the ADS display mode, may reduce the horn-shaped height difference between the sub color filter layer and the black matrix, omits the process steps for producing the planarization layer, but can maintain good flatness, and can effectively eliminate the height difference between the sub color filter layer and the black matrix. The method according to the present embodiment effectively reduces the bad issues, such as DNU, Rubbling Mura at the cell end, which may be generated in the subsequent producing processes, while simplifying the process steps.

In addition, some display panels in a TN display mode in the prior art can be produced without using the planarization layer, however, the subsequent post spacer must be produced in a blue sub-pixel display area. In contrast, in the color filter substrate according to the present embodiment, the post spacer may be kept to be produced in the non-display area, in the case that the planarization layer is omitted or not used, thereby improving the aperture ratio of the pixel.

In the color filter substrate according to the present embodiment, the upper surface of the black matrix and the upper surface of the sub color filter layer are substantially flush with each other, and the color filter substrate has a simple structure, may effectively decrease the height difference between the sub color filter layer and the black matrix. Accordingly, in the method for manufacturing the color filter substrate, the production of the black matrix combines the photolithography and development technology and the electrodeposition technology, thereby simplifying the manufacturing process.

In summary, the color filter substrate is redesigned from a viewpoint of the basic structure thereof, effectively solves the technical problem in the prior art that the manufacturing method of the color filter substrate is relatively complex and the height difference between film layers is too large, thoroughly eliminates the cause of the height difference, and effectively achieves the planarization of the height of the color filter substrate. Such color filter substrate favorably facilitate improvement about the bad issues, such as Rubbling Mura, LCM DNU, in the subsequent production processes, no matter which one of the e ADS display mode or TN display mode is applied for the display product. It has a predominant advantage in terms of the positions of the post spacer, no matter whether the planarization layer is used or not.

### Second Embodiment

A display panel includes the color filter substrate according to the first embodiment.

The above-described color filter substrate may be assembled with an array substrate, and liquid crystal molecules may be filled between them, so as to form a liquid crystal display panel.

Since the display panel uses the above-described color filter substrate, the upper surface of which has a good flatness, it has an excellent display effect.

### Third Embodiment

A display device includes the display panel according to the second embodiment.

The display device may be any product or component having a display function, such as a liquid crystal panel, an electronic paper, a mobile phone, a tablet computer, a television set, a display screen, a notebook computer, a digital photo frame, a navigator, or the like.

The display device has an excellent display effect.

It should be understood that the above embodiments are merely exemplary embodiments intended to explain the principle of the present disclosure, however, the present disclosure is not limited thereto. Various modifications and alternatives may be made to the embodiments of the present disclosure without deviating from the spirit and scope of the present disclosure, and all the modifications and alternatives shall be deemed to fall within the scope of the present disclosure.

What is claimed is:

1. A color filter substrate, comprising:
a substrate;
a color filter layer disposed on the substrate, the color filter layer comprising a plurality of sub color filter layers spaced apart from each other;
a process electrode layer disposed on the substrate and within a gap between any two adjacent sub color filter layers; and
a black matrix disposed within the gap between the any two adjacent sub color filter layers and on the corresponding process electrode layer, and connected with the adjacent sub color filter layer without any overlap therebetween.

2. The color filter substrate according to claim 1, wherein an upper surface of the black matrix is flush with an upper surface of the adjacent sub color filter layer.

3. The color filter substrate according to claim 1, wherein the black matrix is formed through electrodepositing a material containing ions by means of an electric field generated by the process electrode layer.

4. The color filter substrate according to claim 1, wherein each of a width of the black matrix and a width of the corresponding process electrode layer is equal to a width of the gap between the adjacent sub color filter layers, and a sum of a thickness of the black matrix and a thickness of the corresponding process electrode layer is equal to a thickness of the adjacent sub color filter layer.

5. The color filter substrate according to claim 4, wherein the thickness of the black matrix is in a range of ¾ to ⅚ of the thickness of the adjacent sub color filter layer.

6. The color filter substrate according to claim 1, wherein material of the black matrix comprises resin, colorant, curing agent, cosolvent and solvent, wherein the resin comprises acrylic resin or polyester resin, the colorant comprises carbon black or lamp black, the curing agent comprises melamine, the cosolvent comprises alcohol material or ether alcohol material, and the solvent comprises deionized water.

7. The color filter substrate according to claim 1, wherein the process electrode layer is made of conductive material, which comprises indium tin oxide.

8. The color filter substrate according to claim 1, wherein the color filter substrate further comprises a common electrode layer or post spacers disposed on the black matrix and the sub color filter layers.

9. A method for manufacturing the color filter substrate according to claim 1, comprising steps of:
forming a pattern comprising the plurality of sub color filter layers spaced apart from each other on the substrate of the color filter substrate;
forming the process electrode layer within the gap between the any two adjacent sub color filter layers; and
forming a pattern comprising the black matrix on the process electrode layer.

10. The method according to claim 9, wherein the step of forming the pattern comprising the black matrix on the process electrode layer comprises:
coating black matrix material on the process electrode layer and the sub color filter layers, and forming the pattern of the black matrix within the gap between the any two adjacent sub color filter layers by means of electrodeposition through energizing the process electrode layer, wherein the black matrix is connected with the adjacent sub color filter layer without any overlap therebetween.

11. The method according to claim 9, wherein material of the black matrix comprises resin, colorant, curing agent, cosolvent and solvent, wherein the resin comprises acrylic resin or polyester resin, the colorant comprises carbon black or lamp black, the curing agent comprises melamine, the cosolvent comprises alcohol material or ether alcohol material, and the solvent comprises deionized water.

12. The method according to claim 9, wherein the step of forming the process electrode layer within the gap between the any two adjacent sub color filter layers comprises:
forming a photoresist layer comprising a pattern of the process electrode layer on the substrate provided with the sub color filter layers, forming a process electrode film layer on the photoresist layer, and forming the process electrode layer within the gap between the any two adjacent sub color filter layers by a peeling-off process.

13. The method according to claim 9, wherein the process electrode layer is made of conductive material, which comprises indium tin oxide.

14. The method according to claim 9, wherein each of a width of the black matrix and a width of the corresponding process electrode layer is equal to the width of the gap between the two adjacent sub color filter layers, and a sum of a thickness of the black matrix and a thickness of the corresponding process electrode layer is equal to a thickness of the adjacent sub color filter layer.

15. The method according to claim 14, wherein the thickness of the black matrix is in a range of ¾ to ⅚ of the thickness of the adjacent sub color filter layer.

16. The method according to claim 9, further comprising a step of forming a pattern of a common electrode layer on the black matrix or the sub color filter layers, or a step of forming post spacers on the black matrix or the sub color filter layers.

17. The method according to claim 9, wherein an upper surface of the black matrix is flush with an upper surface of the adjacent sub color filter layer.

18. A display panel, comprising the color filter substrate according to claim 1.

19. A display device, comprising the display panel according to claim 18.
